(19) United States
(12) Patent Application Publication
(10) Pub. No.: US 2008/0174534 A1
(43) Pub. Date: Jul. 24, 2008

(54) APPARATUS AND METHOD FOR COMPENSATING AN IMAGE DISPLAY

(76) Inventor: Po-Yun Park, Chungcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/854,403

(22) Filed: Sep. 12, 2007

(30) Foreign Application Priority Data
Sep. 15, 2006 (KR) 2006-89562

(51) Int. Cl. G09G 3/36

(52) U.S. Cl. 345/87

(57) ABSTRACT

An image-compensating apparatus includes an input dividing part, a storing part, a gray scale compensating part, and an output synthesizing part. The input dividing part divides an n-th frame datum into the most significant bit(s) of the n-th frame datum and the least significant bit(s) of the n-th frame datum. The storing part stores the most significant bit(s) of an (n−1)-th frame datum. The gray scale compensating part outputs the most significant bit(s) of an n-th frame compensated datum by using the most significant bit of the n-th frame datum and the most significant bit(s) of the (n−1)-th frame datum. The output synthesizing part synthesizes the most significant bit(s) of the n-th frame compensated datum and the least significant bit(s) of the n-th frame datum to output the n-th frame compensated datum.

### CROSS-REFERENCE TO RELATED APPLICATIONS

The present application claims priority under 35 U.S.C. § 119 to Korea Patent Application No. 2006-89562, filed on Sep. 15, 2006, in the Korean Intellectual Property Office (KIPO), the contents of which are herein incorporated by reference in their entirety.

### BACKGROUND OF THE INVENTION

1. Field of the Invention

The present invention relates to an image-compensating method and apparatus for enhancing liquid crystal response time without increasing memory size.

2. Description of the Related Art

A liquid crystal display (LCD) apparatus includes a liquid crystal display panel and a backlight assembly. The LCD panel includes an array substrate, an opposing substrate opposite to the array substrate, and a liquid crystal layer disposed between the array substrate and the opposing substrate. The backlight assembly provides the LCD panel with light. While a cathode ray tube display apparatus displays an image through an impulse driving method, the LCD apparatus displays an image through a sample and hold method.

Since the LCD apparatus is driven through the sample and hold method, the LCD apparatus may have a slower response time compared to a cathode ray display. Therefore, it is difficult for the LCD apparatus to display movies. In order to solve this problem, the LCD apparatus employs an overshoot driving method to drive the liquid crystal fast.

The overshoot driving method compares a present frame with successive prior frames to excessively drive the present frame. The overshoot driving method requires a memory for storing frame data and a lookup table for storing compensated data to accomplish overshoot driving of the present frame.

Since it is desired that the LCD apparatus have high resolution and good display quality, the number of bits of data applied to the LCD apparatus and output from the LCD apparatus are increased. Accordingly, the size of the memory and lookup table increases as the required number data bits applied to the LCD apparatus increases.

### SUMMARY OF THE INVENTION

According to one aspect of the present invention an image-compensating apparatus capable of enhancing the response speed of liquid crystal without increasing memory size includes an input dividing part, a storing part, a gray scale compensating part, and an output synthesizing part. The input dividing part divides an n-th frame datum into the most significant bit(s) of the n-th frame datum and the least significant bit(s) of the n-th frame datum, and outputs the most significant bit(s) of the n-th frame datum and the least significant bit(s) of the n-th frame datum, wherein “m” and “n” are natural numbers. The storing part stores the most significant bit(s) of the (n−1)-th frame datum. The gray scale compensating part outputs the most significant bit(s) of the n-th frame compensated datum by using the most significant bit(s) of the n-th frame datum and the most significant bit(s) of the (n−1)-th frame datum. The output synthesizing part synthesizes the most significant bit(s) of the n-th frame compensated datum and the least significant bit(s) of the n-th frame datum to output the n-th frame compensated datum.

A method for compensating an image according to another exemplary embodiment includes dividing an n-th frame datum of m-bits into the most significant bit(s) of the n-th frame datum and the least significant bit(s) of the n-th frame datum to output the most significant bit(s) of the n-th frame datum and the least significant bit(s) of the n-th frame datum, using the most significant bit(s) of the n-th frame datum and the stored. most significant bit(s) of an (n−1)-th frame datum to output the most significant bit(s) of the n-th frame compensated datum, and synthesizing the most significant bit(s) of the n-th compensated datum and the least significant bit(s) of the n-th frame datum to output the n-th frame compensated datum of m-bits, wherein “m” and “n” are natural numbers.

An image-compensating apparatus according to another exemplary embodiment includes an input dividing part, a storing part, a first gray scale compensating part, a second gray scale compensating part, an LSB generating part, and an output synthesizing part. The input dividing part divides an (n+1)-th frame datum of m-bits into the most significant bit of the (n+1)-th frame datum and the least significant bit of the (n+1)-th frame datum, and outputs the most significant bit of the (n+1)-th frame datum and the least significant bit of the (n+1)-th frame datum. The storing part stores an (n−1)-th frame datum and the n-th frame datum. The first gray scale compensating part outputs a first most significant bit of an n-th frame compensated datum by using the most significant bit of the n-th frame datum and a most significant bit of the (n−1)-th frame datum. The second gray scale compensating part compares the first most significant bit of the n-th frame compensated datum with a first setting value and further compares the most significant bit of the (n+1)-th frame datum with a second setting value to change the first most significant bit of the n-th frame compensated datum into a second most significant bit of the n-th frame compensated datum. The LSB generating part compares the (n−1)-th, n-th, and (n+1)-th frame datum with each other to generate a least significant bit of the n-th frame compensated datum. The output synthesizing part synthesizes the second most significant bit of the n-th frame compensated datum and the least significant bit of the n-th frame datum to output an n-th frame compensated datum.

A method for compensating an image according to another exemplary embodiment includes dividing an (n+1)-th frame datum of m-bit into a most significant bit of the (n+1)-th frame datum and a least significant bit of the (n+1)-th frame datum to output the most significant bit of the (n+1)-th frame datum and the least significant bit of the (n+1)-th frame datum, using a most significant bit of a stored n-th frame datum and a most significant bit of a stored (n−1)-th frame datum to output a first most significant bit of an n-th frame compensated datum, comparing the first significant bit of the n-th frame compensated datum with a first setting value and a most significant bit of the (n+1)-th frame datum with a second setting value to change the first most significant bit of the n-th frame compensated datum into a second most significant bit of the n-th frame compensated datum, comparing most significant bits of the (n−1)-th, n-th, and (n+1)-th frame data with each other to generate a least significant bit of the n-th frame compensated datum, and synthesizing the second most significant bit of the n-th frame compensated datum and the least significant bit of the n-th frame datum to output the n-th frame compensated datum of m-bit.

A display apparatus according to another exemplary embodiment includes a display panel, an image compensator, a source driver, and a gate driver. The display panel displays an image. The display panel includes a plurality of data lines and a plurality of gate lines crossing the data lines. The image compensator divides a frame datum of m-bit into a most significant bit of the frame datum and a least significant bit of the frame datum and compensates the most significant bit of the frame datum, wherein “m” is a natural number of 10 or more. The image compensator synthesizes the compensated most significant bit of the frame datum and the least significant bit of the frame datum to output a frame compensated datum of m-bit. The source driver changes the frame compensated datum of m-bit into an analog typed data voltage and outputs the analog typed data voltage to the data lines. The gate driver generates gate signals and outputs the gate signals to the gate lines.

The image-compensating apparatus, the method for compensating an image, and the display apparatus do not require an extra memory and an extra lookup table for compensating expanded data signals. Therefore, manufacturing costs may be reduced.

### BRIEF DESCRIPTION OF THE DRAWINGS

The above and other features and advantages of the present invention will become more apparent by describing in detailed example embodiments thereof with reference to the accompanying drawings, in which:

FIG. 1 is a block diagram illustrating an image-compensating apparatus according to an exemplary embodiment of the present invention;

FIG. 2 is a block diagram illustrating a gray scale compensating part shown in FIG. 1;

FIG. 3 is a table showing an example of a lookup table shown in FIG. 2;

FIG. 4 is a concept diagram illustrating an operating system of an operating part shown in FIG. 2;

FIG. 5 is a flow chart illustrating a driving system of the image-compensating apparatus shown in FIG. 1;

FIG. 6 is a block diagram illustrating an image-compensating apparatus according to another exemplary embodiment of the present invention;

FIGS. 7 to 10 are graphs showing a variation of gray scales of (n−1)-th, n-th and (n+1)-th data;

FIGS. 11A and 11B are a flow chart illustrating a driving system of the image-compensating apparatus shown in FIG. 6; and

FIG. 12 is a block diagram illustrating a display apparatus according to another exemplary embodiment of the present invention.

### DESCRIPTION OF THE EMBODIMENTS

In the drawings, the size and relative sizes of layers and regions may be exaggerated for clarity. It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features.

Embodiments of the invention are described herein with reference to cross-section illustrations that are schematic illustrations of idealized embodiments (and intermediate structures) of the invention. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Hereinafter, the present invention will be explained in detail with reference to the accompanying drawings. In the following description the terms least significant bit and most significant bit may be used interchangeably with least significant bits and most significant bits or least significant bit(s) and most significant bit(s), as the context requires.

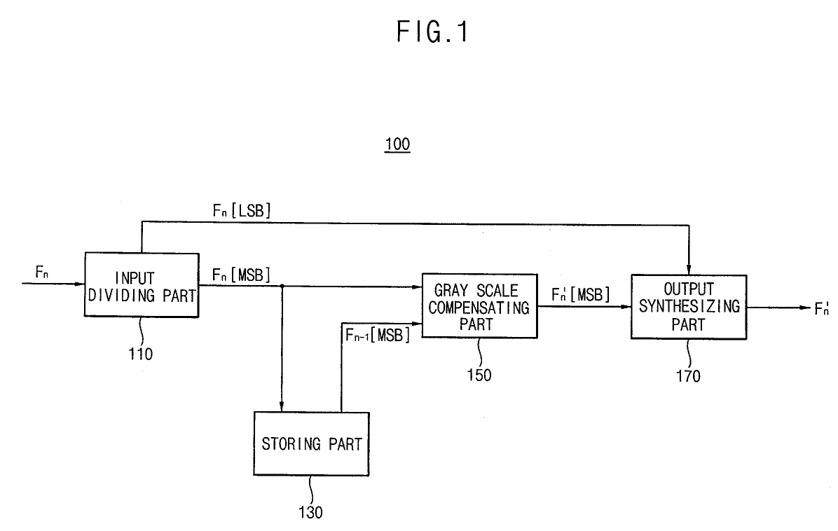

FIG. 1 is a block diagram illustrating an image-compensating apparatus according to an exemplary embodiment of the present invention.

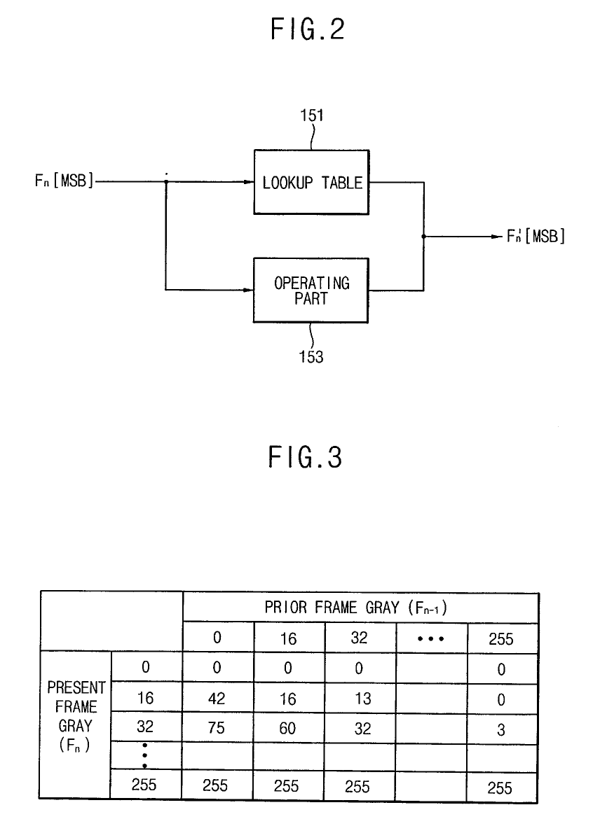

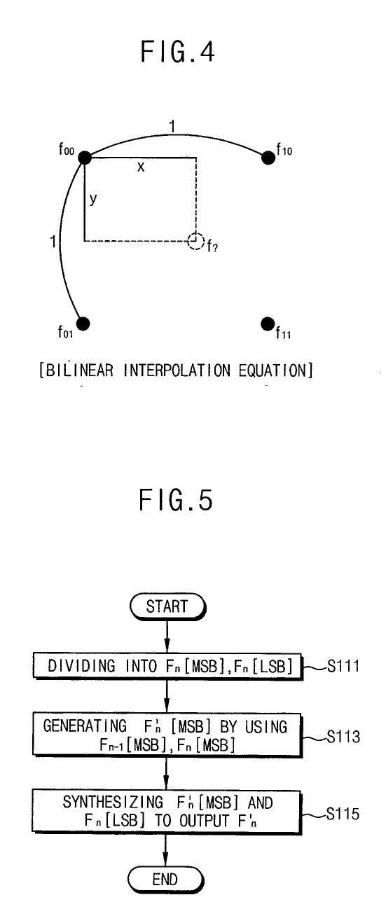

FIG. 2 is a block diagram illustrating a gray scale compensating part shown in FIG. 1. FIG. 3 is a table showing an example of a lookup table shown in FIG. 2. FIG. 4 is a concept diagram illustrating an operating system of an operating part shown in FIG. 2.

Referring to FIG. 1, the image-compensating apparatus 100 includes an input dividing part 110, a storing part 130, a gray scale compensating part 150, and an output synthesizing part 170.

The input dividing part 110 divides a received datum into a most significant bit MSB and a least significant bit LSB, and outputs the most significant bit MSB and the least significant bit LSB.

For example, the input dividing part 110 divides a received datum Fn of an n-th frame into a most significant bit Fn[MSB] of the datum Fn and a least significant bit Fn[LSB] of the datum Fn and outputs the most significant bit Fn[MSB] of the datum Fn and the least significant bit Fn[LSB] of the datum Fn. When the received datum is m-bit, the input dividing part 110 divides the received datum into the most significant bit MSB of the received datum, which is 8-bit, and the least significant bit LSB of the received datum, which is (m31 8)-bit, and outputs the most significant bit MSB of the received datum and the least significant bit LSB of the received datum, wherein “n” is a natural number and “m” is a natural number of ten or more.

Hereinafter, the datum of the n-th frame will be referred to as an n-th datum Fn, a datum of an (n−1)-th frame will be referred to as an (n−1)-th datum Fn−1, and a compensated datum of an n-th frame will be referred to as an n-th compensated datum Fn′.

The storing part 130 stores the most significant bit Fn[MSB] of the n-th datum outputted from the input dividing part 110. The storing part 130 has stored the most significant bit Fn−1[MSB] of the (n−1)-th datum.

The gray scale compensating part 150 uses the most significant bit Fn[MSB] of the n-th datum and the most significant bit Fn−1[MSB] of the (n−1)-th datum to output the most significant bit F′n[MSB] of the n-th compensated datum.

Referring to FIG. 2, the gray scale compensating part 150 includes a lookup table 151 and an operating part 153. When an X-axis of the lookup table 151 refers to the most significant bit Fn−1[MSB] of the (n−1)-th datum and a Y-axis of the lookup table 151 refers to the most significant bit Fn[MSB] of the n-th datum, the lookup table 151 contains a compensated datum corresponding to the most significant bit Fn−1[MSB] of the (n−1)-th datum and the most significant bit Fn[MSB] of the n-th datum.

Referring to FIG. 3, when the most significant bit MSB of each datum is 8-bit, the lookup table 151 is embodied in 16×16 sizes. For example, when the most significant bit Fn[MSB] of the n-th datum is ‘16’ and the most significant bit Fn−1[MSB] of the (n−1)-th datum is ‘0’, ‘42’ is outputted as the most significant bit F′n[MSB] of the n-th compensated datum.

The operating part 153 operates the compensated datum by using a Bilinear's formula shown in the following equation 1 when the lookup table 151 does not include a corresponding compensated datum.

f=f₀₀×(1−X)(1−Y)+f₁₀×X(1−Y)+f₀₁×(1−X)Y+f₁₁×XY [Equation 1]

Each of the ‘f₀₀’ and ‘f₁₀’ refers to a gray scale of the (n−1)-th datum existing in the lookup table 151, and each of the ‘f₀₁’ and ‘f₁₀’ refers to a gray scale of the n-th datum existing in the lookup table 151.

Referring to FIG. 4, when ‘f₀₀+X’ is inputted as the most significant bit Fn−1[MSB] of the (n−1)-th datum and ‘f₀₀+Y’ is inputted as the most significant bit Fn[MSB] of the n-th datum, the operating part 153 operates the compensated datum ‘f’ by using the equation 1 and outputs the compensated datum ‘f’.

When the most significant bits Fn[MSB] and Fn−1[MSB] are 8-bit respectively, the lookup table having 16×16 size is employed in the gray scale compensating part 150 to decrease the size of the lookup table, and a compensated datum corresponding to a halftone gray scale that does not exist in the lookup table is generated by the Bilinear's formula. However, the gray scale compensating part 150 may employ a lookup table having a size 256×256.

The output synthesizing part 170 synthesizes the most significant bit F′n[MSB] of the n-th compensated datum outputted to the gray scale compensating part 150 and the least significant bit Fn[LSB] of the n-th datum outputted from the input dividing part 110 to output the n-th compensated datum F′n.

Therefore, bits of the n-th datum Fn are substantially the same as bits of the n-th compensated datum F′n.

FIG. 5 is a flow chart illustrating a driving system of the image-compensating apparatus shown in FIG. 1.

Referring to FIGS. 1 and 5, the input dividing part 110 divides the n-th datum into the most and least significant bits Fn[MSB] and Fn[LSB] of the n-th datum and outputs the most and least significant bits Fn[MSB] and Fn[LSB] of the n-th datum (step S111).

The gray scale compensating part 150 uses the most significant bits Fn[MSB] and Fn−1[MSB] of the n-th and (n−1)-th data to output the most significant bit F′n[MSB] of the n-th compensated datum (step S113).

The output synthesizing part 170 synthesizes the most significant bit F′n[MSB] of the n-th compensated datum and the least significant bit Fn[LSB] of the n-th datum, and outputs the n-th compensated datum F′n (step S115).

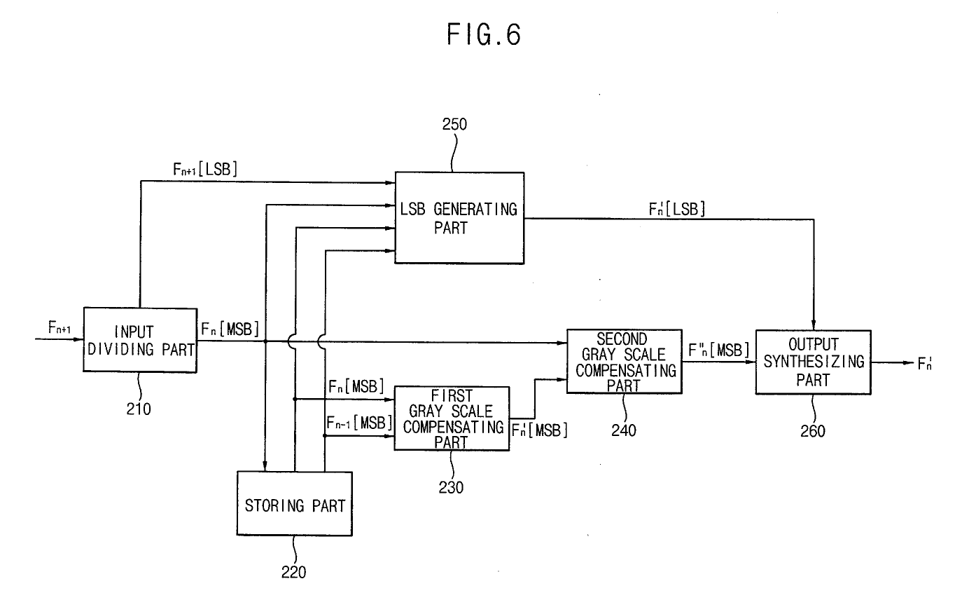

FIG. 6 is a block diagram illustrating an image-compensating apparatus according to another exemplary embodiment of the present invention.

Referring to FIG. 6, the image-compensating apparatus 200 includes an input dividing part 210, a storing part 220, a first gray scale compensating part 230, a second gray scale compensating part 240, an LSB generating part 250, and an output synthesizing part 260.

The input dividing part 210 divides a received datum into a most significant bit MSB and a least significant bit LSB and outputs the most significant bit MSB and the least significant bit LSB. For example, the input dividing part 210 divides the (n+1)-th datum Fn+1 into the most and least significant bits Fn+1[MSB] and Fn+1 [LSB] of the (n+1)-th datum and outputs the most and least significant bits Fn+1[MSB] and Fn+1 [LSB].

Hereinafter, a datum of an (n+1)-th frame will be referred to as an (n+1)-th datum Fn+1, a datum of an n-th frame will be referred to as an n-th datum Fn, a datum of an (n−1)-th frame will be referred to as an (n−1)-th datum, and a compensated datum of n-th frame will be referred to as an n-th compensated datum F′n.

The storing part 220 stores the most significant bit MSB of each datum divided by the input dividing part 210. The storing part 220 stores at least two serial frame data.

For example, the most significant bit Fn+1[MSB] of the (n+1)-th datum outputted by the input dividing part 210 is stored in the storing part 220. The most significant bits Fn[MSB] and Fn−1[MSB] of the n-th and (n−1)-th data having stored in the storing part 220 are read out from the storing part 220 and applied to the first gray scale compensating part 230.

The first gray scale compensating part 230 uses the most significant bits Fn−1[MSB] and Fn[MSB] of the (n−1)-th and n-th data to output a first most significant bit F′n[MSB] of the n-th compensated datum. The first gray scale compensating part 230 may be embodied by a lookup table and an operating part as shown in FIG. 2. Alternately, the first gray scale compensating part 230 may be embodied by a single lookup table.

The second gray scale compensating part 240 compares the first most significant bit F′n[MSB] with the most significant bit Fn+1[MSB] of the (n+1)-th datum outputted by the input dividing part 210 to change the first most significant bit F′n[MSB] of the n-th compensated datum into a second most significant bit F″n[MSB] of the n-th compensated datum.

For example, the first most significant bit F′n[MSB] of the n-th compensated datum is compared with a first setting value T1, and the most significant bit Fn+1[MSB] of the (n+1)-th datum is compared with a second setting value T2. The first setting value T1 is a gray scale close to a lowest gray scale and the second setting value T2 is a gray scale close to a highest gray scale.

When the first most significant bit F′n[MSB] of the n-th compensated datum is smaller than the first setting value T1 and the most significant value Fn+1[MSB] of the (n+1)-th datum is larger than the second setting value T2, the second gray scale compensating part 240 changes the first most significant bit F′n[MSB] of the n-th compensated datum into the second most significant bit F″n[MSB]. In this case, the second most significant bit F″n[MSB] of the n-th compensated datum is a pre-tilted gray scale.

When the first most significant bit F′n[MSB] of the n-th compensated datum is larger than the first setting value T1 and the most significant value Fn+1[MSB] of the (n+1)-th datum is smaller than the second setting value T2, the second gray scale compensating part 240 outputs the first most significant bit F′n[MSB] of the n-th compensated datum as the second most significant bit F″n[MSB] of the n-th compensated datum.

For example, when the first most significant bit F′n[MSB] of the n-th compensated datum is a black gray scale and the most significant bit Fn+1[MSB] of the (n+1)-th datum is a white gray scale, the second gray scale compensating part 240 outputs a pre-tilted gray scale as the second most significant bit F″n[MSB] of the n-th compensated datum.

Alternately, when the first most significant bit F′n[MSB] of the n-th compensated datum is not a black gray scale or the most significant bit Fn+1[MSB] of the (n+1)-th datum is not a white gray scale, the second compensating part 240 outputs the first most significant bit F′n[MSB] of the n-th compensated datum as the second most significant bit F″n[MSB] of the n-th compensated datum.

The LSB generating part 250 compares the most significant bits Fn-1[MSB], Fn[MSB], and Fn+1[MSB] with each other to generate a least significant bit F′n[LSB] of the n-th compensated datum.

The output synthesizing part 260 synthesizes the second most significant bit F″n[MSB] of the n-th compensated datum outputted by the second gray scale compensating part 240, and the least significant bit F′n[LSB] of the n-th compensated datum outputted by the LSB generating part 250 to generate an n-th compensated datum F′n, and outputs the n-th compensated datum F′n.

Therefore, bits of the n-th datum Fn inputted to the image-compensating apparatus 200 is substantially the same as bits of the n-th compensated datum F′n outputted from the image-compensating apparatus 200.

The LSB generating part 250 is divided into first to fifth cases according to the gray scale variation of the most significant bits Fn−1[MSB], Fn[MSB], and Fn+1[MSB] of the (n−1)-th, n-th, and (n+1)-th data. In each of the first to fifth case, the LSB generating part 250 generates the least significant bit F′n[LSB] of the n-th compensated datum.

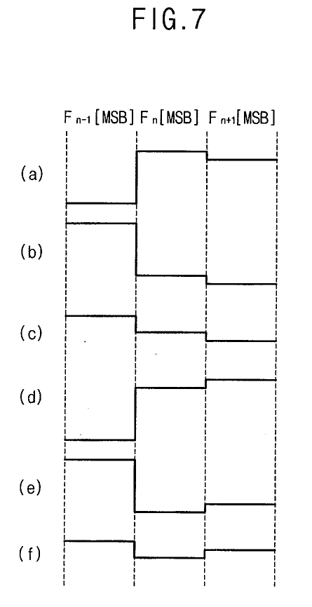

FIGS. 7 to 10 are graphs showing a variation of gray scales of (n−1)-th, n-th and (n+1)-th data. Hereinafter, a driving system of the LSB generating part will be described in reference to the FIGS. 6 to 10 and a 10-bit datum will be described as an example.

In the first case, the second most significant bit F″n[MSB] outputted by the second gray scale compensating part 240 is a white gray scale, which is 255 (‘11111111’). In this case, the first most significant bit F′n[MSB] of the n-th compensated datum compensated by the first gray scale compensating part 230 is a white gray scale.

Therefore, since the least significant bit(s) F″n[LSB] of the n-th compensated datum may be a white gray scale, the LSB generating part 250 outputs ‘11’ as the least significant bit F′n[LSB] of the n-th compensated datum.

In the second case, an absolute value of difference between the most significant bit Fn+1[MSB] of the (n+1)-th datum and the most significant bit Fn[MSB] of the n-th datum is smaller than a first critical value T12 (|Fn+1[MSB]−Fn[MSB]|<T12). The first critical value is about 10.

As shown in FIG. 7, a gray scale corresponding to the most significant bit Fn+1[MSB] of the (n+1)-th datum is similar to a gray scale corresponding to the most significant bit Fn[MSB] of the n-th datum in the second case.

Therefore, the LSB generating part 250 uses the least significant bit Fn+1[LSB] of the (n+1)-th datum as the least significant bit F′n[LSB] of the n-th compensated datum in the second case.

In the third case, the absolute value of a value difference between the most significant bit Fn+I[MSB] of the (n+1)-th datum and the most significant bit Fn[MSB] of the n-th datum is larger than a second critical value T22 and a value difference between the most significant bit Fn[MSB] of the n-th datum and the most significant bit Fn−1[MSB] of the (n−1)-th datum is larger than a third critical value T23 (|Fn+1[MSB]−Fn[MSB]|>T22, Fn[MSB]−Fn−1[MSB]>T23). The second critical value T22 is about 200 and the third critical value T23 is about 10.

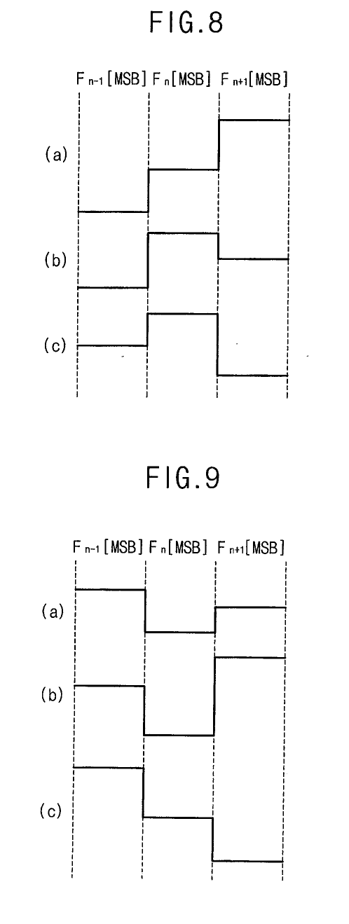

As shown in FIG. 8, a gray scale of the n-th datum is larger than a gray scale of the (n−1)-th datum in the third case. Namely, the gray scale has been increased in the third case. When the gray scale is increased, the increasing velocity of the gray scale may accelerate to improve a response time. However, a gray scale of the (n+1)-th datum may be larger than a gray scale of the n-th datum as shown by the line (a) in FIG. 8 or smaller than a gray scale of the n-th datum as shown by the lines (b) and (c) in FIG. 8 in the (n+1)-th frame.

Therefore, the LSB generating part 250 generates the least significant bit F′n[LSB] of the n-th compensated datum in proportion to a difference value (Fn[MSB]−Fn−1[MSB]) between the most significant bits Fn[MSB] and Fn−1[MSB] of the n-th and (n−1)-th data.

For example, when the difference value (Fn[MSB]−Fn−1[MSB]) between the most significant bits Fn[MSB] and Fn−1[MSB] of the n-th and (n−1)-th data is in a range of about 0 to about 63, the LSB generating part 250 generates ‘00’ as the least significant bit F′n[LSB] of the n-th compensated datum. When the difference value (Fn[MSB]−Fn−1[MSB]) between the most significant bits Fn[MSB] and Fn−1[MSB] of the n-th and (n−1)-th data is in a range of about 64 to about 127, the LSB generating part 250 generates ‘01’ as the least significant bit F′n[LSB] of the n-th compensated datum. When the difference value (Fn[MSB]−Fn−1[MSB]) between the most significant bits Fn[MSB] and Fn−1[MSB] of the n-th and (n−1)-th data is in a range of about 128 to about 191, the LSB generating part 250 generates ‘10’ as the least significant bit F′n[LSB] of the n-th compensated datum. When the difference value (Fn[MSB]−Fn−1[MSB]) between the most significant bits Fn[MSB] and Fn−1[MSB] of the n-th and (n−1)-th data is in a range of about 192 to about 255, the LSB generating part 250 generates ‘11’ as the least significant bit F′n[LSB] of the n-th compensated datum.

In the fourth case, the absolute value of the value difference between the most significant bit Fn+1[MSB] of the (n+1)-th datum and the most significant bit Fn[MSB] of the n-th datum is larger than the second critical value T22 and a difference value between the most significant bit Fn−1 [MSB] of the (n−1)-th datum and the most significant bit Fn[MSB] of the n-th datum is larger than the third critical value T23 (|Fn+1[MSB]−Fn[MSB]|>T22, Fn−1[MSB]−Fn[MSB]>T23).

As shown in FIG. 9, the gray scale of the n-th datum is lower than a gray scale of the (n−1)-th datum in the fourth case. Namely, the gray scale has been lowered in the fourth case. Since the fourth case is reverse to the third case, the LSB generating part 250 may generate the least significant bit F′n[LSB] proportionate to the difference value between the most significant bits Fn[MSB] and Fn−1[MSB] of the n-th and (n−1)-th data in consideration of the most significant bit Fn+1[MSB] of the (n+1)-th datum.

However, since the gray scale becomes lowered, the fourth case is more easily recognized. Therefore, it is preferable to accelerate the lowering velocity to prevent the case from being easily recognized.

Accordingly, the LSB generating part 250 generates ‘00’ as the least significant bit F′n[LSB] of the n-th compensated datum.

In the fifth case, the absolute value of the value difference between the most significant bit Fn+1[MSB] of the (n+1)-th datum and the most significant bit Fn[MSB] of the n-th datum is larger than the second critical value T22 and an absolute value of the value difference between the most significant bit Fn−1[MSB] of the (n−1)-th datum and the most significant bit Fn[MSB] of the n-th datum is smaller than the third critical value T23. (|Fn+1[MSB]−Fn [MSB]|>T22, |Fn−1[MSB]−Fn [MSB]|<T23)

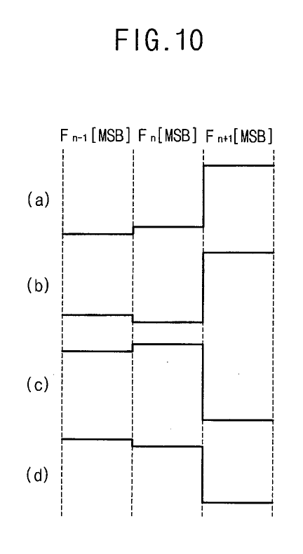

A gray scale of the (n+1)-th datum may be larger than a gray scale of the n-th datum as shown by the lines (a) and (b) in FIG. 10 or may be smaller than a gray scale of the n-th datum as shown by the lines (c) and (d) in FIG. 10 in the fifth case.

When the gray scale of the (n+1)-th datum is larger than a gray scale of the n-th datum as shown by the lines (a) and (b) in FIG. 10, the response velocity is compulsively controlled to be fast since the increasing velocity is generally slower than the dropping velocity in a patterned vertical alignment (PVA) mode panel. Therefore, the LSB generating part 250 may generate ‘11’ as the least significant bit F′n[LSB] of the n-th compensated datum.

When the gray scale of the (n+1)-th datum is smaller than a gray scale of the n-th datum as shown by the lines (c) and (d) in FIG. 10, the response velocity is compulsively controlled to be slow. Therefore, the LSB generating part 250 may generate ‘11’ as the least significant bit F′n[LSB] of the n-th compensated datum to let the dropping velocity be slow.

Consequently, the LSB generating part 250 generates ‘11’ as the least significant bit F′n[LSB] of the n-th compensated datum in the fifth case.

Above, the 10-bit datum has been described as an example. The LSB generating part 250 generates the least significant bit F′n[LSB] of the n-th compensated datum of 4-bit when the frame datum is 12-bit.

For example, the LSB generating part 250 generates ‘1111’ as the least significant bit F′n[LSB] of the n-th compensated datum in the first case. The LSB generating part 250 generates the least significant bit Fn+I[LSB] of the (n+1)-th datum as the least significant bit F′n[LSB] of the n-th compensated datum in the second case. The LSB generating part 250 generates the least significant bit F′n[LSB] of the n-th compensated datum in proportion to the difference value (Fn[MSB]−Fn−1[MSB]) between the most significant bit Fn[MSB] of the n-th datum and the most significant bit Fn−1[MSB] of the (n−1)-th datum. For example, when the difference value (Fn[MSB]−Fn−1[MSB]) is in a range of about 0 to about 16, the LSB generating part 250 generates ‘0000’ as the least significant bit F′n[LSB] of the n-th compensated datum.

When the difference value (Fn[MSB]−Fn−1[MSB]) is in a range of about 17 to about 32, the LSB generating part 250 generates ‘0001’ as the least significant bit F′n[LSB] of the n-th compensated datum. When the difference value (Fn[MSB]−Fn−1[MSB]) is in a range of about 240 to about 255, the LSB generating part 250 generates ‘1111’ as the least significant bit F′n[LSB] of the n-th compensated datum. The LSB generating part 250 generates ‘0000’ in the fourth case and ‘1111’ in the fifth case.

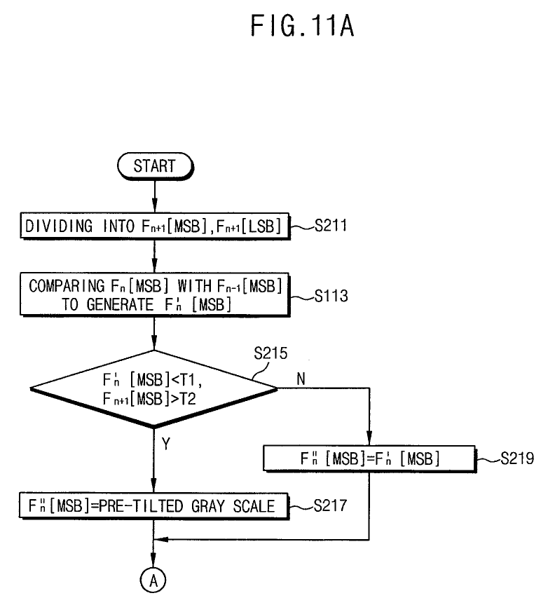

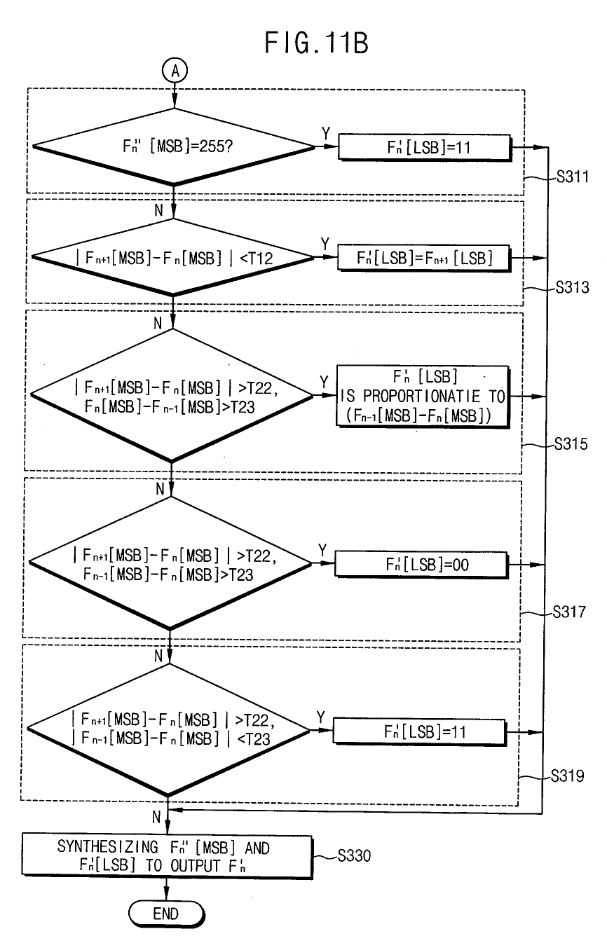

FIGS. 11A and 11B are a flow chart illustrating a driving system of the image-compensating apparatus shown in FIG. 6.

Referring to FIGS. 6, 11A, and 11B, the input dividing part 210 divides the (n+1)-th datum into the most significant bit Fn+1[MSB] of the (n+1)-th datum and the least significant bit Fn+1[LSB] of the (n+1)-th datum and outputs the most significant bit Fn+1[MSB] of the (n+1)-th datum and the least significant bit Fn+1 [LSB] of the (n+1)-th datum. (step S211)

The first gray scale compensating part 230 uses the most significant bit Fn−1[MSB] of the (n−1)-th datum and the most significant bit Fn[MSB] of the n-th datum to output the first most significant bit F′n[MSB] of the n-th compensated datum. (step S213)

The second gray scale compensating part 240 compares the first most significant bit F′n[MSB] of the n-th compensated datum with the first setting value T1. The second gray scale compensating part 240 also compares the most significant bit Fn+1[MSB] of the (n+1)-th datum with the second setting value T2. (step S215)

When the first most significant bit F′n[MSB] of the n-th compensated datum is smaller than the first setting value T1 and the most significant bit Fn+1[MSB] of the (n+1)-th datum is larger than the second setting value T2, the second gray scale compensating part 240 outputs a pre-tilted gray scale as the second most significant bit F″n[MSB] of the n-th compensated datum. (step S217)

When the first most significant bit F′n[MSB] of the n-th compensated datum is larger than the first setting value T1 and the most significant bit Fn+1[MSB] of the (n+1)-th datum is smaller than the second setting value T2, the second gray scale compensating part 240 outputs the first most significant bit F′n[MSB] of the n-th compensated datum as the second most significant bit F″n[MSB] of the n-th compensated datum. (step S219)

The LSB generating part 250 compares the most significant bits Fn-1[MSB], Fn[MSB], and Fn+I[MSB] of the (n−1)-th, n-th, and (n+1)-th data with each other to output the least significant bit F′n[MSB] of the n-th compensated datum.

When the second most significant bit F″n[MSB] of the n-th compensated datum has the value of “1”, the LSB generating part 250 generates the least significant bit F′n[LSB] of the n-th compensated datum having a value of “1”. (step S311) For example, when the least significant bit F′n[LSB] of the n-th compensated datum is 2-bits, the LSB generating part 250 generates ‘11’ as the least significant bits F′n[LSB] of the n-th compensated datum. When the least significant bits F′n[LSB] of the n-th compensated datum is 4-bits, the LSB generating part 250 generates ‘1111’ as the least significant bits F′n[LSB] of the n-th compensated datum.

When the absolute value of the difference between the most significant bits Fn+1[MSB] and Fn[MSB] of the (n+1)-th and n-th data is smaller than the first setting value T1 (|Fn+1[MSB]−Fn[MSB]|<T1), the LSB generating part 250 outputs the least significant bits Fn+1[LSB] of the (n+1)-th datum as the least significant bits F′n[LSB] of the n-th compensated datum. (step S313)

When the absolute value of the difference between the most significant bits Fn+1[MSB] and Fn[MSB] of the (n+1)-th and n-th data is larger than the second setting value T2 (|Fn+1[MSB]−Fn[MSB]|>T2) and the value difference between the most significant bits Fn[MSB] and Fn−1[MSB] of the n-th and (n−1)-th data is larger than the third critical value T23 (I Fn+1[MSB]−Fn[MSB]|>T23), the LSB generating part 250 generates the least significant bit F′n[LSB] of the n-th compensated datum in proportion to the value difference (Fn−1[MSB]−Fn[MSB]) between the most significant bits Fn−1[MSB] and Fn[MSB] of the (n−1)-th and n-th data. (step S315)

Fourthly, when the absolute value of the value difference between the most significant bits Fn+1[MSB] and Fn[MSB] of the (n+1)-th and n-th data is larger than the second critical value T22 (|Fn+1[MSB]−Fn[MSB]|>T22) and the value difference between the most significant bits Fn−1[MSB] and Fn[MSB] of the (n−1)-th and n-th data is larger than the third critical value T23 (|Fn+1[MSB]−Fn[MSB]|>T23), the LSB generating part 250 generates the least significant bit F′n[LSB] of the n-th compensated datum having a value of “0”. For example, the LSB generating part 250 generates ‘00’ when the least significant bit F′n[LSB] of the n-th compensated datum is 2-bit. The LSB generating part 250 generates ‘0000’ when the least significant bit F′n[LSB] of the n-th compensated datum is 4-bit. (step S317)

Fifthly, when the absolute value of the difference value between the most significant bits Fn+1[MSB] and Fn[MSB] of the (n+1)-th and n-th data is larger than the second critical value T22 (|Fn+1[MSB]−Fn[MSB]|>T22) and the absolute value of the difference value between the most significant bits Fn−1[MSB] and Fn[MSB] of the (n−1)-th and n-th data is smaller than the third critical value T23 (|Fn+1[MSB]−Fn[MSB]|<T23), the LSB generating part 250 generates the least significant bit F′n[LSB] of the n-th compensated datum having a value of “1”. (step S319) For example, the LSB generating part 250 generates ‘11’ when the least significant bit F′n[LSB] of the n-th compensated datum is 2-bit. The LSB generating part 250 generates ‘1111’ when the least significant bit F′n[LSB] of the n-th compensated datum is 4-bit.

The output synthesizing part 260 synthesizes the second most significant bit F′n[MSB] of the n-th compensated datum outputted by the second gray scale compensating part 240 and the least significant bit F′n[LSB] of the n-th compensated datum outputted by the LSB generating part 250 to output the n-th compensated datum F′n. (step S330)

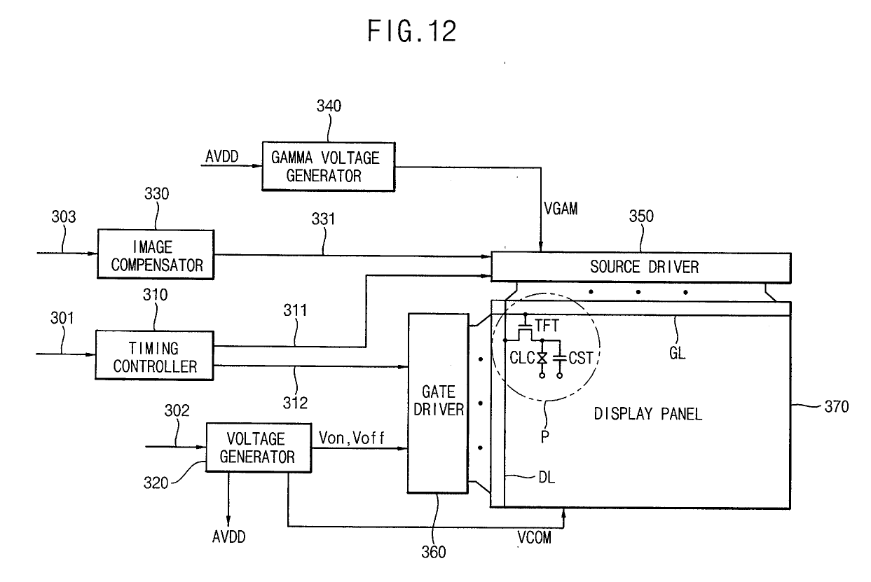

FIG. 12 is a block diagram illustrating a display apparatus according to a third exemplary embodiment of the present invention.

Referring to FIG. 12, the display apparatus includes a timing controller 310, a voltage generator 320, an image compensator 330, a gamma voltage generator 340, a source driver 350, a gate driver 360, and a display panel 370.

The timing controller 310 generates a driving control signal on the basis of a primitive control signal 301

received from an external graphic controller (not shown). The driving control signal includes a first driving control signal 311 controlling the source driver 350 and a second driving control signal 312 controlling the gate driver 360. The first driving control signal 311 includes a horizontal start signal STH, a datum clock signal DCLK, and a load signal TP. The second driving control signal 312 includes a vertical start signal STV, a clock signal CLK, and an inversion clock signal CKLB.

The voltage generator 320 uses an external power source 302 to generate a driving voltage for driving the display apparatus. For example, the driving voltage includes a source voltage AVDD to drive the gamma voltage generator 340, a gate voltage Von and Voff to drive the gate driver 360, and a common voltage VCOM to drive the display apparatus.

The image compensator 330 is the same as the image-compensating apparatus shown in FIG. 1 or FIG. 5.

The image compensator 330 divides a data signal 303, which is m-bit, into a most significant bit of the data signal, which is 8-bit, and a least significant bit of the data signal, which is (m−8)-bit. The image compensator 330 compensates a gray scale of the most significant bit of the data signal and synthesizes the compensated most significant bit of the data signal and the least significant bit of the data signal to output the compensated datum signal 331 of m-bit.

The image compensator 330 does not expand a memory and a lookup table for compensating a conventional data signal of 8-bit. Namely, even though the image compensator 330 uses the memory and the lookup table for compensating the conventional datum signal of 8-bit, the image compensator 330 compensates an expanded data signal of m-bit to output a compensated data signal of m-bit. Therefore, it may not be necessary that a size of each of the memory and the lookup table for compensating the expanded data signal of m-bit becoming larger.

Elements and operations of the image compensator 330 have been described in reference to FIGS. 1 and 5. Thus, any further explanation concerning the elements and operations of the image compensator 330 will be omitted.

The gamma voltage generator 340 uses a predetermined gamma curve to generate reference gamma voltages VGAM corresponding to reference gray scales of electric field gray scales of the data signal.

The source driver 350 uses the reference gamma voltages VGAM to change the compensated data signal outputted by the image compensator 330 into analog typed datum voltages on the basis of the first driving control signal 311. The source driver 350 outputs the data voltages to the display panel 370.

The gate driver 360 generates gate signals having a gate-on voltage Von and a gate-off voltage Voff on the basis of the second driving control signal 312. The gate driver 360 sequentially outputs the gate signals to the display panel 370.

The display panel 370 includes a plurality of data lines DL and a plurality of gate lines GL. The data and gate lines define a plurality of pixels. Each pixel P includes a switching element TFT connected to the data and gate lines DL and GL, a liquid crystal capacitor CLC electrically connected to the switching element TFT, and a storage capacitor CST.

Each of the data lines DL is connected to an output terminal of the source driver 350 and receives the data voltage. Each of the gate lines GL is connected to an output terminal of the gate driver 360 and receives the gate signal. When the gate signal is applied to the gate line GL, the switching element TFT is turned on and the data voltage applied to the data line DL is charged in the liquid crystal capacitor CLC and the storage capacitor CST. The display panel 370 displays a gray scale of an image according to the data voltage charged in the liquid crystal capacitor CLC.

As mentioned above, even though the present invention may not change the size of each of the memory and the lookup table employed to the conventional image compensator for compensating 8-bit data signals to improve response velocity of a movie, the present invention may easily compensate data signals, each of the data signals being more than 8-bit. Therefore, since the present invention does not require an extra memory and an extra lookup table for compensating the expanded data signals, manufacturing costs may be reduced.

Having described the exemplary embodiments of the present invention and its advantage, it is noted that various changes, substitutions and alterations can be made herein without departing from the spirit and scope of the invention as defined by appended claims.

What is claimed is:

1. An image-compensating apparatus comprising:
an input dividing part dividing an n-th frame datum into the most significant bit(s) of the n-th frame datum and the least significant bit(s) of the n-th frame datum;
a storing part storing the most significant bit(s) of an (n−1)-th frame datum;
a gray scale compensating part outputting the most significant bit(s) of the n-th frame compensated datum by using the most significant bit(s) of the n-th frame datum and the most significant bit(s) of the(n−1)-th frame datum; and
an output synthesizing part synthesizing the most significant bit(s) of the n-th frame compensated datum and the least significant bit(s) of the n-th frame datum to output the n-th frame compensated datum,
wherein “n” is a natural number.

2. The image-compensating apparatus of claim 1, wherein the most significant bit(s) of the frame datum is 8-bit and the least significant bit(s) of the frame datum is (m−8)-bit, when the frame datum is m-bit, wherein “m” is a natural number of ten or more.

3. The image-compensating apparatus of claim 1, wherein the gray scale compensating part comprises a lookup table containing the most significant bit(s) of the n-th frame compensated datum corresponding to the most significant bit(s) of the n-th frame datum and the most significant bit(s) of the (n−1)-th frame datum.

4. The image-compensating apparatus of claim 3, wherein the gray scale compensating part further comprises an operating part operating the most significant bit(s) of the n-th frame compensated datum corresponding to the most significant bit(s) of the n-th frame datum and outputting the most significant bit(s) of the n-th frame compensated datum.

5. A method for compensating an image comprising:
dividing an n-th frame datum of m-bit into a most significant bit(s) of the n-th frame datum and a least significant bit(s) of the n-th frame datum to output the most significant bit(s) of the n-th frame datum and the least significant bit(s) of the n-th frame datum;
outputting a most significant bit(s) of an n-th frame compensated datum by using the most significant bit(s) of the n-th frame datum and a stored most significant bit(s) of an (n−1)-th frame datum; and
synthesizing the most significant bit(s) of the n-th compensated datum and a least significant bit(s) of the n-th frame datum to output an n-th frame compensated datum of m-bit,
wherein “m” and “n” are natural numbers.

6. An image-compensating apparatus comprising:
an input dividing part dividing an (n+1)-th frame datum into the most significant bit(s) of the (n+1)-th frame datum and the least significant bit(s) of the (n+1)-th frame datum to output the most significant bit(s) of the (n+1)-th frame datum and the least significant bit(s) of the (n+1)-th frame datum;
a storing part storing an (n−1)-th frame datum and an n-th frame datum;
a first gray scale compensating part outputting a first most significant bit(s) of an n-th frame compensated datum by using the most significant bit(s) of the n-th frame datum and the most significant bit(s) of the (n−1)-th frame datum;
a second gray scale compensating part comparing the first most significant bit(s) of the n-th frame compensated datum with a first setting value and comparing the most significant bit(s) of the (n+1)-th frame datum with a second setting value to change the first most significant bit(s) of the n-th frame compensated datum into a second most significant bit(s) of the n-th frame compensated datum;
an LSB generating part comparing the (n−1)-th, n-th, and (n+1)-th frame data with each other to generate the least significant bit(s) of the n-th frame compensated datum; and
an output synthesizing part synthesizing the second most significant bit(s) of the n-th frame compensated datum and the least significant bit(s) of the n-th frame datum to output an n-th frame compensated datum.

7. The image-compensating apparatus of claim 6, wherein the most significant bit(s) of the frame datum is 8-bit and the least significant bit(s) of the frame datum is (m−8)-bit, when the frame datum is m-bit, wherein the “m” is a natural number of ten or more.

8. The image-compensating apparatus of claim 6, wherein the first gray scale compensating part comprises a lookup table containing the most significant bit(s) of the n-th frame compensated datum corresponding to the most significant bit(s) of the n-th frame datum and the most significant bit(s) of the (n−1)-th frame datum.

9. The image-compensating apparatus of claim 8, wherein the first gray scale compensating part further comprises an operating part operating the most significant bit(s) of the n-th frame compensated datum corresponding to the most significant bit(s) of the n-th frame datum and outputting the most significant bit(s) of the n-th frame compensated datum.

10. The image-compensating apparatus of claim 6, wherein the second gray scale compensating part compensates the first most significant bit(s) of the n-th frame compensated datum to output the second most significant bit(s) of the n-th frame compensated datum, when the first most significant bit(s) of the n-th frame compensated datum is smaller than the first setting value and the most significant bit(s) of the (n+1)-th frame datum is larger than the second setting value.

11. The image-compensating apparatus of claim 10, wherein the second gray scale compensating part outputs the first most significant bit(s) of the n-th frame compensated datum as the second most significant bit(s) of the n-th frame compensated datum, when the first significant bit(s) of the n-th frame compensated datum is larger than the first setting value and the most significant bit(s) of the (n+1)-th frame datum is smaller than the second setting value.

12. The image-compensating apparatus of claim 6, wherein the LSB generating part generates the least significant bit(s) of the n-th frame compensated datum having a value of “1”, when the second most significant bit(s) of the n-th frame compensated datum has a value of “1”.

13. The image-compensating apparatus of, claim 12, wherein the LSB generating part outputs the least significant bit(s) of the (n+1)-th frame datum as the least significant bit(s) of the n-th frame compensated datum, when an inequality |Fn+I[MSB]−Fn[MSB]|<T12 is satisfied, wherein Fn+1[MSB] is the most significant bit(s) of the (n+1)-th frame datum, Fn[MSB] is the most significant bit(s) of the n-th frame datum, and T12 is a first critical value.

14. The image-compensating apparatus of claim 13, wherein the LSB generating part generates the least significant bit(s) of the n-th frame compensated datum substantially in proportion to a value difference between the most significant bit(s) of the (n−1)-th frame datum and the most significant bit(s) of the n-th frame datum, when inequalities |Fn+1[MSB]−Fn[MSB]|>T22 and Fn[MSB]−Fn−1[MSB]>T23 are satisfied, wherein Fn−1[MSB] is the most significant bit(s) of the (n−1)-th frame datum, T22 is a second critical value, and T23 is a third critical value.

15. The image-compensating apparatus of claim 14, wherein the LSB generating part generates the least significant bit(s) of the n-th frame compensated datum having a value of zero, when inequalities |Fn+1[MSB]−Fn[MSB]|>T22 and Fn−1[MSB]−Fn[MSB]>T23 are satisfied.

16. The image-compensating apparatus of claim 15, wherein the LSB generating part generates the least significant bit(s) of the n-th frame compensated datum having a value of one, when inequalities |Fn+1[MSB]−Fn[MSB]|>T22 and |Fn−1[MSB]−Fn[MSB]|<T23 are satisfied.

17. A method for compensating an image, comprising:
dividing an (n+1)-th frame datum of m-bits into the most significant bit(s) of the (n+1)-th frame datum and the least significant bit(s) of the (n+1)-th frame datum to output the most significant bit(s) of the (n+1)-th frame datum and the least significant bit(s) of the (n+1)-th frame;
outputting the first most significant bit(s) of an n-th frame compensated datum by using the most significant bit(s) of a stored n-th frame datum and the most significant bit(s) of a stored (n−1)-th frame datum;
comparing the first significant bit of the n-th frame compensated datum with a first setting value and the most significant bit(s) of the (n+1)-th frame datum with a second setting value to change the first most significant bit(s) of the n-th frame compensated datum into the second most significant bit(s) of the n-th frame compensated datum;
comparing the most significant bits of the (n−1)-th, n-th, and (n+1)-th frame data with each other to generate the least significant bit(s) of the n-th frame compensated datum; and
synthesizing the second most significant bit(s) of the n-th frame compensated datum and the least significant bit(s) of the n-th frame datum to output the n-th frame compensated datum of m-bit.

18. The method of claim 17, wherein comparing the first significant bit(s) of the n-th frame compensated datum with a first setting value and a most significant bit(s) of the (n+1)-th frame datum with a second setting value to change the first most significant bit(s) of the n-th frame compensated datum into the second most significant bit(s) of the n-th frame compensated datum, comprises:
changing the first most significant bit(s) of the n-th frame compensated datum into the second most significant bit(s) of the n-th frame compensated datum to output the second most significant bit(s) of the n-th frame compensated datum, when the first most significant bit(s) of the n-th frame compensated datum is smaller than the first setting value and the most significant bit(s) of the (n+1)-th frame datum is larger than the second setting value.

19. The method of claim 18, wherein comparing the first significant bit(s) of the n-th frame compensated datum with a first setting value and a most significant bit(s) of the (n+1)-th frame datum with a second setting value to change the first most significant bit(s) of the n-th frame compensated datum into a second most significant bit(s) of the n-th frame compensated datum, comprises:
outputting the first most significant bit(s) of the n-th frame compensated datum as the second most significant bit(s) of the n-th frame compensated datum, when the first most significant bit(s) of the n-th frame compensated datum is larger than the first setting value and the most significant bit(s) of the (n+1)-th frame datum is smaller than the second setting value.

20. The method of claim 17, wherein comparing most significant bits of the (n−1)-th, n-th, and (n+1)-th frame data with each other to generate the least significant bit(s) of the n-th frame compensated datum, comprises:
generating the least significant bit(s) of the n-th frame compensated datum having a value of one, when the second most significant bit(s) of the n-th frame compensated datum has a value of one.

21. The method of claim 20, wherein comparing most significant bits of the (n−1)-th, n-th, and (n+1)-th frame data with each other to generate the least significant bit(s) of the n-th frame compensated datum, comprises:
outputting the least significant bit(s) of the (n+1)-th frame datum as the least significant bit(s) of the n-th frame compensated datum, when an inequality |Fn+1[MSB]−Fn[MSB]|<T12 is satisfied, wherein Fn+1[MSB] is the most significant bit(s) of the (n+1)-th frame datum, Fn[MSB] is the most significant bit(s) of the n-th frame datum, and T12 is a first critical value.

22. The method of claim 21, wherein comparing most significant bits of the (n−1)-th, n-th, and (n+1)-th frame data with each other to generate the least significant bit(s) of the n-th frame compensated datum, comprises:
generating the least significant bit(s) of the n-th frame compensated datum in proportion to a difference value between the most significant bit(s) of the (n−1)-th frame datum and the most significant bit(s) of the n-th frame datum, when inequalities |Fn+1[MSB]−Fn[MSB]|>T22 and Fn[MSB]−Fn−1[MSB]|>T23 are satisfied, wherein Fn−1[MSB] is the most significant bit(s) of the (n−1)-th frame datum, T22 is a second critical value, and T23 is a third critical value.

23. The method of claim 22, wherein comparing most significant bits of the (n−1)-th, n-th, and (n+1)-th frame data with each other to generate a least significant bit of the n-th frame compensated datum, comprises:
generating the least significant bit(s) of the n-th frame compensated datum having a value of zero, when inequalities |Fn+1[MSB]−Fn[MSB]|>T22 and Fn−1[MSB]−Fn[MSB]>T23 are satisfied.

24. The method of claim 23, wherein comparing most significant bits of the (n−1)-th, n-th, and (n+1)-th frame data with each other to generate the least significant bit(s) of the n-th frame compensated datum, comprises:
generating the least significant bit(s) of the n-th frame compensated datum having a value of one, when inequalities |Fn+1[MSB]−Fn[MSB]|>T22 and |Fn−1[MSB]−Fn[MSB]|<T23 are satisfied.

25. A display apparatus comprising:
a display panel displaying an image, the display panel including a plurality of data lines and a plurality of gate lines crossing the data lines;
an image compensator dividing a frame datum of m-bit into the most significant bit(s) of the frame datum and the least significant bit(s) of the frame datum, compensating the most significant bit(s) of the frame datum, and synthesizing the compensated most significant bit(s) of the frame datum and the least significant bit(s) of the frame datum to output a frame compensated datum of m-bit;
a source driver changing the frame compensated datum of m-bit into an analog typed data voltage and outputting the analog typed data voltage to the data lines; and
a gate driver generating gate signals and outputting the gate signals to the gate lines, wherein “m” is a natural number of 10 or more.

26. The display apparatus of claim 25, wherein the most significant bit(s) of the frame datum is 8-bit and the least significant bit(s) of the frame datum is (m−8)-bit.

27. The display apparatus of claim 25, wherein the image compensator comprises:
an input dividing part dividing an n-th frame datum into the most significant bit(s) of the n-th frame datum and the least significant bit(s) of the n-th frame datum, and outputting the most significant bit(s) of the n-th frame datum and the least significant bit(s) of the n-th frame datum;
a storing part storing a most significant bit(s) of an (n−1)-th frame datum;
a gray scale compensating part output an n-th frame compensated datum by using the most significant bit(s) of the n-th frame datum and the most significant bit(s) of the (n−1)-th frame datum; and
an output synthesizing part synthesizing the most significant bit(s) of the n-th frame compensated datum and the least significant bit(s) of the n-th frame datum to output the n-th frame compensated datum.

28. The display apparatus of claim 25, wherein the image compensator comprises;
an input dividing part dividing an (n+1)-th frame datum into the most significant bit(s) of the (n+1)-th frame datum and the least significant bit(s) of the (n+1)-th frame datum and outputting the most significant bit(s) of the (n+1)-th frame datum and the least significant bit(s) of the (n+1)-th frame datum;
a storing part storing an (n−1)-th frame datum and an n-th frame datum;
a first gray scale compensating part output a first most significant bit of the n-th frame compensated datum by using the most significant bit(s) of the n-th frame datum and the most significant bit(s) of the (n−1)-th frame datum;
a second gray scale compensating part comparing the first most significant bit(s) of the n-th frame compensated datum with a first setting value and the most significant bit(s) of the (n+1)-th frame datum with a second setting value to change the first most significant bit(s) of the n-th frame compensated datum into the second most significant bit(s) of the n-th frame compensated datum;
an LSB generating part comparing the (n−1)-th, n-th, and (n+1)-th frame data with each other to generate the least significant bit(s) of the n-th frame compensated datum; and
an output synthesizing part synthesizing the second most significant bit(s) of the n-th frame compensated datum and the least significant bit(s) of the n-th frame datum to output the n-th frame compensated datum.
